(19) United States
(12) Patent Application Publication
(10) Pub. No.: US 2023/0385363 A1
(43) Pub. Date: Nov. 30, 2023

(54) WEB SITE PREVIEW GENERATION BASED ON WEB SITE TYPE

(71) Applicant: Microsoft Technology Licensing, LLC, Redmond, WA (US)

(72) Inventors: Joseph Michael GLOCKE, Seattle, WA (US); Archana SASEETHARAN, Sammamish, WA (US); Bhrighu SAREEN, Kirkland, WA (US); Sukhmani LAMBA, Bellevue, WA (US); Ankit GOVIL, Redmond, WA (US); David Pierre CLAUX, Redmond, WA (US); Saurav MAJUMDER, Lynnwood, WA (US); Mao YU, Bellevue, WA (US); Daniel Dong Joon SEONG, Bellevue, WA (US); Aditya CHAUDHRY, Newcastle, WA (US); Nehal Balkrishna BHAGAT, Vancouver (CA); Rahul Kishore PINJANI, Bellevue, WA (US); Mengli ELMENDORF, Montgomery, NY (US)

(21) Appl. No.: 17/752,675

(22) Filed: May 24, 2022

(51) Int. Cl. G06F 16/957; G06F 16/958; G06F 40/106

(52) U.S. Cl. CPC G06F 16/9577; G06F 16/958; G06F 40/106

(57) ABSTRACT

The automated generation of a web site preview based on a type of the web site. In response to receiving the web site identifier from the client computing system, the service uses the web site identifier to navigate to the web site identified by the web site identifier. After navigating to that web site, the service accesses a type of the web site from the web site. The service selects a predetermined preview template at least in part based on the type of the web site, and populates at least some of the content from the web site to generate the web site preview. Because the web site preview is based on the type of web site, the user sees consistent previews across different web sites of the same type (though the owner might have the option to supersede with their own preview).

### BACKGROUND

A Uniform Resource Locator (or URL) is a text string identifier that uniquely identifies a resource on the web. As an example, URLs can identify web sites. URLs of web sites are commonly input into a web browser to cause the browser to navigate to the respective web site. In addition, URLs are often associated with selectable links (often called “hyperlinks”) within a web site. Selection of a hyperlink causes the browser to navigate to the web site identified by the URL associated with the hyperlink.

URLs can be used in other ways as well. For example, a URL can be input into a chat window, which can potentially cause the system to render a limited preview of the web site. As an example, the preview might include an image, limited text, and perhaps a hyperlink that, when selected, allows for navigation to the web site associated with the link. This gives the user a better idea of what the web site offers as compared to simply presenting only the text of the URL. Thus, the user knows a little more about the web site to allow the user to make a more informed decision on whether to select the hyperlink. Once the user selects the hyperlink and has navigated to the web site, the user can then navigate through the web site (e.g., by selecting hyperlinks or controls) to perform various actions while at the web site.

As an example, the user might navigate to a web site that offers products for sale, and then thereafter perform actions to purchase a product. As another example, the user might navigate to a web site that is promoting an event, and thereafter select hyperlinks or controls to find out more about the event, buy tickets for the event, or find out where on a map the event is. As yet another example, the user might navigate to a restaurant web site, and thereafter view a menu, or make reservations.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The principles described herein relate to the automated generation of a web site preview based on a type of the web site. In response to receiving the web site identifier from the client computing system, the service uses a web site identifier to navigate to the web site identified by the web site identifier. After navigating to that web site, the service accesses a type of the web site from the web site. The service selects a predetermined preview template at least in part based on the type of the web site, and populates at least some of the content from the web site. This generates preview data that is structured to be interpreted by the client computing system to cause the client computing system to render a web site preview that defines how the web site preview will be rendered. The service then causes the preview data to be sent to the client computing system.

Because the web site preview is based on the type of web site, the user sees consistent previews across different web sites of the same type (though the owner of the web site may have the option to provide their own preview in some embodiments). Thus, the user becomes familiar with the web site previews. Furthermore, the previews are specifically tailored for a particular type of web site. Also, the web site is alleviated from having to design their own web site previews.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates a flowchart of a method for generating a web site preview based on a web site identifier, in accordance with the principles described herein;

FIG. 2 illustrates a network environment that includes a client computing system and a preview service computing system, which represents an example environment in which the method of FIG. 1 may be performed;

FIG. 3 illustrates a flowchart of a method for generating a preview of the web site identified by the web site identifier by using templates and based at least in part on a type of a web site, in accordance with one embodiment described herein;

FIG. 4 illustrates a data flow that may be executed using the method of FIG. 3;

FIG. 5 illustrates a data flow in which some web site content is populated into a copy of the selected preview template, which in one example generates the preview data that is returned to the client;

FIG. 6A illustrates an example web site preview of an airline web site;

FIG. 6B illustrates an example code review web site preview;

FIG. 7 illustrates a flowchart of a method for selecting a preview template first based on web site entity, and then based on web site type;

FIG. 8 illustrates a general example of a web site preview that includes three controls, each with an associated endpoint identifier that facilitates connection to an associated endpoints with respect to interactivity with the control; and

FIG. 9 illustrates an example computing system in which the principles described herein may be employed.

### DETAILED DESCRIPTION

The principles described herein relate to the automated generation of a web site preview based on a type of the web site. In response to receiving the web site identifier from the client computing system, the service uses a web site identifier to navigate to the web site identified by the web site identifier. After navigating to that web site, the service accesses a type of the web site from the web site. The service selects a predetermined preview template at least in part based on the type of the web site, and populates at least some of the content from the web site. This generates preview data that is structured to be interpreted by the client computing system to cause the client computing system to render a web site preview that defines how the web site preview will be rendered. The service then causes the preview data to be sent to the client computing system.

Because the web site preview is based on the type of web site, the user sees consistent previews across different web sites of the same type (though the owner of the web site may have the option to provide their own preview in some embodiments). Thus, the user becomes familiar with the web site previews. Furthermore, the previews are specifically tailored for a particular type of web site. Also, the web site is alleviated from having to design their own web site previews.

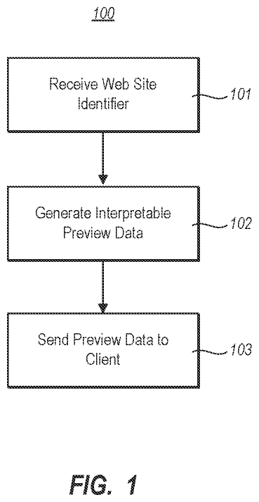

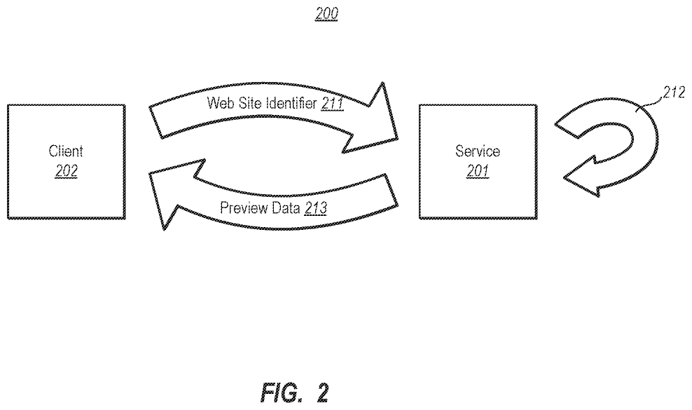

FIG. 1 illustrates a flowchart of a method 100 for generating a web site preview based on a web site identifier, in accordance with the principles described herein. As an example only, the web site identifier may be a Uniform Resource Locator (or URL). FIG. 2 illustrates a network environment 200 which represents an example of an environment in which the principles described herein may operate, and represents an example environment in which method 100 may be performed. Accordingly, the method 100 of FIG. 1 will be described with reference to FIG. 1 as well as with reference to the network environment 200 of FIG. 2.

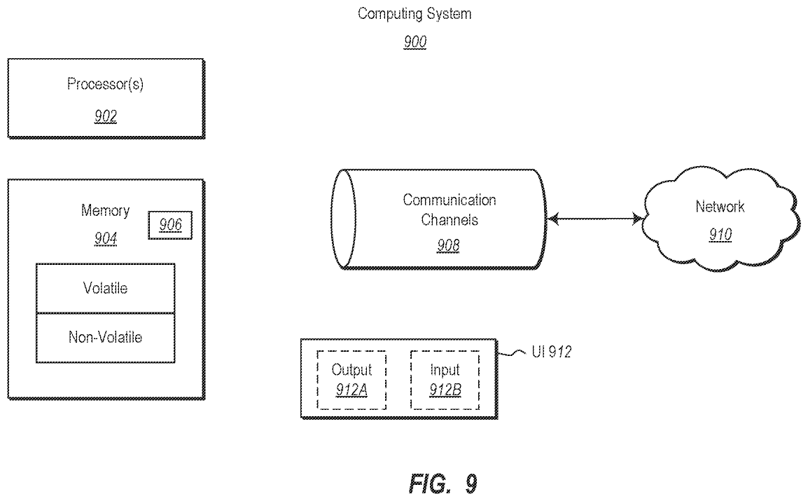

The method 100 may be performed by a service computing system and is initiated upon that service computing system receiving a web site identifier from a client computing system (act 101). Referring to FIG. 2, the network environment 200 includes a service computing system 201 and a client computing system 202. Each of the computing systems 201 and 202 may be structured as described below for the computing system 900 of FIG. 9. In one example of the act 101, the service computing system 201 receives (as represented by arrow 211) a web site identifier from the client computing system 202.

In response to receiving the web site identifier from the client computing system (act 101), the service computing system generates preview data representing a preview of a web site represented by the web site identifier (act 102). In FIG. 2, the generation of the preview data based on the web site identifier is represented by the circular arrow 212. The preview data is structured to be interpreted by the client computing system to cause the client computing system to render a web site preview. In some embodiments, the web site preview is defined by the preview data. Thus, by appropriately generating the preview data, the service computing system controls how the web site preview is rendered by the client computing system.

In accordance with the method 100, after the preview data is generated (act 102), the service computing system then causes the generated preview data to be sent to the client computing system (act 103). As an example, in FIG. 2, the service computing system 201 sends (as represented by the arrow 213) the preview data to the client computing system 202. At the client computing system, the preview data may then be interpreted to render the web site preview. Thus, the user is provided a web site preview associated with a web site identifier.

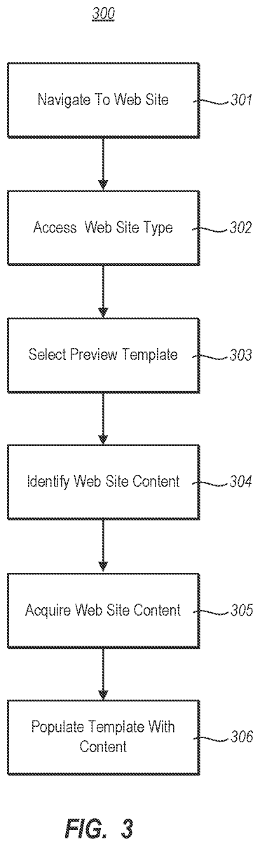

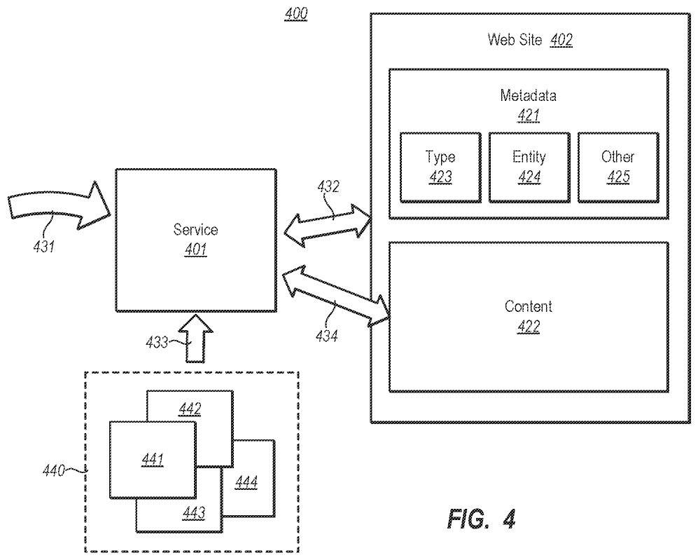

FIG. 3 illustrates a flowchart of a method 300 for generating a preview of the web site identified by the web site identifier. The method 300 represents a more specific example of how the act 102 of FIG. 1 may be performed. FIG. 4 illustrates an environment 400 in which the method 300 may be performed. Accordingly, the method 300 will now be described not only with respect to FIG. 3, but also with frequent reference to the environment 400 of FIG. 4.

Since the method 300 represents an example of the act 102 of FIG. 2, the service computing system has already received the web site identifier at the time that the method 300 is begun. For example, in FIG. 4, the service computing system 401 has received (as represented by arrow 431) the web site identifier that identifies the web site 402.

In accordance with the method 300, the service computing system uses the received web site identifier to navigate to the web site identified by the web site identifier (act 301). If the web site identifier was a URL, then the service could simply use standard web navigation to navigate to the web site. Referring to FIG. 4, the service computing system navigates to the web site 402 associated with the web site identifier. That web site 402 includes metadata 421 and content 422. The metadata 421 could include a type 423 of the web site, perhaps an entity 424 that provides the web site, and potentially other information 425. Such may be structured in accordance with a schema specified within the web site. For instance, the schema might be a version of a schema provided by schema.org.

In the method 300, after navigating to the web site (act 301), the service computing system accesses a type of the web site (act 302). Referring to FIG. 4, the service computing system 401 accesses (e.g., reads) the type 423 of the web site 402 from the metadata 421 of the web site (as an example of act 302), as well as potentially reading other metadata 421. The service computing system accessing such metadata is represented by bi-directional arrow 432 in FIG. 4. In one embodiment, this accessing may be performed by first determining that the web site specifies compliance with the schema (e.g., a particular version of schema.org), and finding the type in the metadata of the web site at a predetermined position defined by the schema.

In the method 300, the service computing system uses the accessed type of the web site (amongst potentially other factors) to select an appropriate preview template (act 303). For example, in FIG. 4, the service computing system 401 may have access to a preview template collection 440. In this example, the collection 440 has four preview templates 441 through 444, but this is just a simple example only. There may be countless preview templates available to the service computing system 401. In this example, suppose that the service selects preview template 442, which selection is represented by arrow 433.

The fields within the template define what content of the web site is to be used to populate the template. Accordingly, the service computing system uses the template to determine what content to populate into the template (act 304), acquires the appropriate content of the web site (act 305) and populates that content into the template (act 306). Referring to FIG. 4, the service computing system 401 uses the template (in this case the selected preview template 442) to determine what web site content to populated into the preview template. The service computing system acquires that content from the web site as represented by bi-directional arrow 434, and populates that content into the web site template (as an example of act 305) to thereby generate the preview data. The populated preview template may then serve is the generated preview data that is then sent to the client.

This preview data may be for example, a data interchange format object, such as a JSON object, which is a sequence of declarations that defines how to render the web site preview. The client may then interpret the preview data to thereby render the web site preview. Although the arrows 432 and 434 are shown separately, all information (metadata and content) required to generate the preview data may be acquired from the web site 402 from a single request and response.

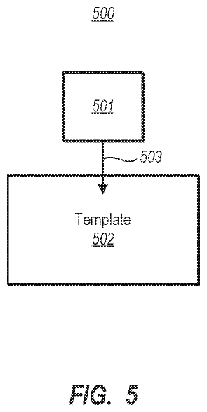

FIG. 5 illustrates a data flow 500 in which some web site content 501 is populated (as represented by arrow 503) into a copy of the selected preview template 502, which in one example generates the preview data that is returned to the client computing system. In another embodiment, the preview data sent to the client includes the web site content 502 and the unpopulated template 501 (perhaps as a single JSON object or multiple JSON objects). The client would then populate the appropriate portion of the content 502 into the unpopulated template 501 as part of rendering the preview data. This has a disadvantage in that it relies upon the client having the capability to perform binding of content 502 into the template 501, which not all clients may have. On the other hand, rendering declarative sequences (such as JSON objects) is a much more universal operation that client computing systems are typically capable of doing. This has an advantage of providing the preview data as an already populated copy of the template.

As described above, the template is selected at least in part based on the web site metadata. As an example, the web site metadata may include a type of web site. For example, a product web site (of type “product”) may by default result in the selection of a product web site preview, a restaurant web site (of type “restaurant”) may by default result in selection of a restaurant web site preview, an airline web site (of type “airline”) may by default result in selection of an airline web site. Such selection does not rely on any input by the web site owner itself. Instead, the selection merely by default pivots on the value of the type field in the web site metadata.

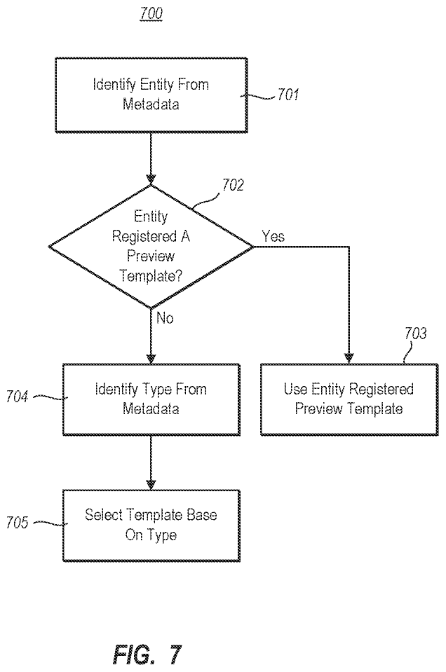

Thus, the user has a consistent preview across all product web site previews, across all restaurant web site previews, and so forth, where those web site previews are tailored towards the type of web site (though the owner of the web site may have the option to provide their own preview in some embodiments such as that described below with respect to FIG. 7). The user is thereby given an intuitive web site preview. Such web site previews may be generated with the aim of providing a robust and rich experience for the user that views and/or interfaces with the web site preview, and may consider input from other stakeholders. Because the service controls how the web site preview appears, rather than have such control left to each client, the user is provided with a much more consistent user experience. Furthermore, because the service computing system is a service that may operate in a cloud computing environment that has abundant processing, memory and storage resources, the generation of the preview may consider a variety of factors and be the result of complex processing, thereby providing a more substantial web site preview.

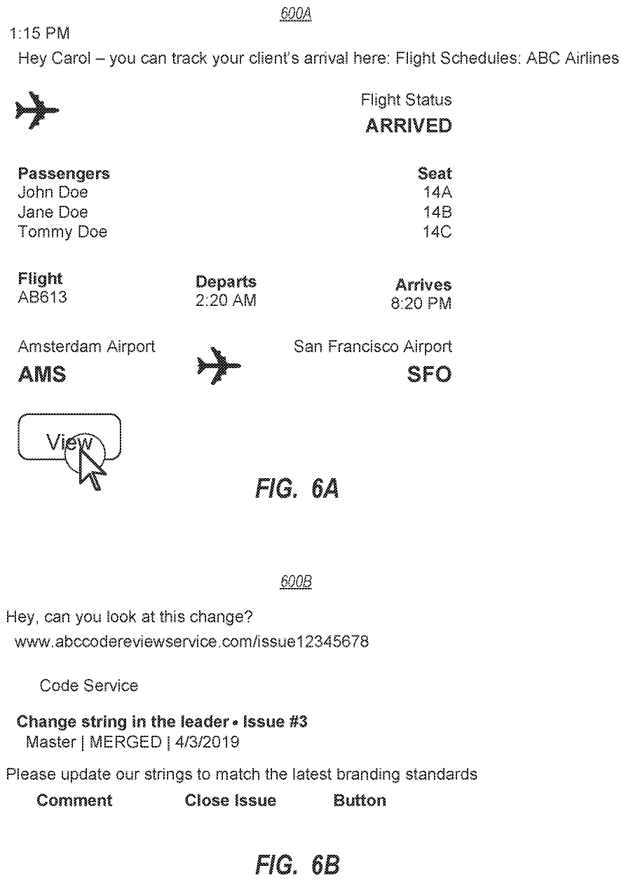

A few user experiences will now be described, FIG. 6A illustrates a text chat window 600A in which a user has sent a chat to Carol (a fictional person) and pasted a web site identifier that results in a preview being rendered within the chat window. Each time the user navigates to an airline web site and a default airline type preview template is selected, the user may be presented with a similar web site preview. As another example user interaction, FIG. 6B illustrates an example code review preview 600B for a fictional code review service for a fictional code review issue. Each time the user navigates to a code review web site and a default code review type preview is selected, the user may be presented with a similar web site preview.

Alternatively, or in addition, relevant metadata used to select the preview template may be the entity expressed in the metadata of the web site. This is the provider of the web site. In one embodiment, that entity can register a particular preview template with the preview service. Thus, in this embodiment, the selection of the preview template depends on the entity.

FIG. 7 illustrates a method 700 that represents an example of such selection, which represents an example of the act 303 of FIG. 3. The selection includes identifying an entity expressed in the web site metadata (at 701), and determining if the entity expressed in the web site metadata has registered a preview template (decision block 702). If the entity has registered a preview template (“Yes” in decision block 702), the registered preview template is then selected (act 703). On the other hand, if the entity has not registered a preview template (“No” in decision block 702), the type from the web site metadata is obtained (act 704) and the template is selected based on that type (act 705).

Other parameters may be used to select an appropriate preview template in addition to the type of the web site and/or the entity of the web site. Such additional parameters may include context information that represents a context (such as an application, window, or the like) in which the preview will be rendered. Such context may be a chat window, a document, a social media post, or the like. The entity may register a different preview template based on each of these contexts. Alternatively, or in addition, the selection may be based on both a type of web site as well as the context in which the web site preview will be presented.

As another example, the selection may be based on a screen size of the client that is to render the web site preview. The screen size may be identified within the request from the client to the preview service. The entity may register a different preview template based on each of multiple screen sizes. Alternatively, or in addition, the selection may be based on both a type of web site as well as the screen size of the client. Thus, the web site entity, the type of the web site, the context in which the preview will be rendered, and the screen size of the client that will render the preview (or various combinations of the above) may be used to select the appropriate preview template.

Accordingly, the principles described herein provide a rich preview experience, where generation of the preview is determined based on data performed at a preview service. Typically, when a web site preview is presented to a user, the preview may act as a hyperlink (or otherwise contain a hyperlink) that when selected, navigates the user to the web site that was previewed by the web site preview. Then, the user can interact with the web site as normal including interacting with any controls provided by the web site.

However, in accordance with some embodiments of the principles described herein, one or more controls of the web site are provided within the web site preview itself. Thus, a user can use those controls without even navigating to the web site. As an example, in FIG. 4A, there are controls that update to reflect flight status, and controls that may be selected to view a flight tracker. In FIG. 4B, there is a control to change the status of a code review.

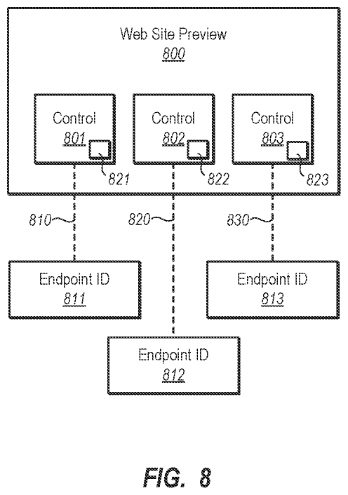

For illustrative purposes only, FIG. 8 illustrates a general example of a web site preview 800 that includes three controls 801, 802 and 803, each with associated endpoint identifiers 811, 812 and 813. The endpoint identifiers can be any identifier that the client computing system can use to further connection to the endpoint identified by the associated endpoint identifier. In one example, such endpoint identifiers are also URLs. The web site preview may include other web site content as well, such as images, text (e.g., descriptions, summaries, titles), and others, although this other content is not represented in FIG. 8 in order to allow for focus on the controls themselves. FIG. 8 is just an example. The principles described herein are not limited to the number of action controls within a web site preview.

As represented by dashed lines 810, 820 and 830, each control is associated with endpoint identifiers 811, 812 and 813 respectively. The controls also have corresponding configurations 821, 822 and 823 that define the type of connection that is facilitated by the respective control. Thus, the control 801 facilitates a specific type of connection defined by the configuration 821 to the endpoint identified by the endpoint identifier 811. Furthermore, in this example, the control 802 facilitates a specific type of connection defined by the configuration 822 to the endpoint identified by the endpoint identifier 812. Lastly in this example, the control 803 facilitates a specific type of connection defined by the configuration 823 to the endpoint identified by the endpoint identifier 813.

One example of a connection type is a navigation connection type in which the client computing system is navigated to the endpoint in response to its user interacting with the control. Such a control will be referred to herein as a “navigation control”. Another example of a connection type is an input connection type in which the user can provide input (e.g., text, a Boolean, a selection from a group, or the like) to the connected endpoint. Such a control will be referred to herein as an “input control”. Another example of a connection type is an output connection in which the endpoint provides data to populate into the control, and perhaps even update that data. Such a control will be referred to herein as an “output control”.

These are just three different examples of a connection type and associated control type. The principles described herein apply regardless of the type of connection that the control facilitates. Furthermore, the principles described herein apply regardless of the form of the control, regardless of layout, design, color, size, shape, user interactivity types, and so forth.

Examples of navigation controls will now be described. For instance, if the web site is a restaurant web site, an example navigation control could be a description control, that when interacted with, takes the user to a description endpoint maintained by the restaurant that is perhaps managed by the restaurant. As another example, there may also be a navigation control in the form of a menu control that when interacted with, takes the user to a menu endpoint maintained by the restaurant that presents a menu of the restaurant. These endpoints may for instance be within the domain of the web site that is being previewed (in this case, the restaurant web site).

However, there may also be controls with endpoints that are completely outside of the domain of the restaurant web site. As examples, there may be a navigation control to make a reservation for the restaurant, which when interacted with takes the user to a reservation service endpoint that is not managed by the restaurant web site. As another example, the restaurant web site preview may provide a navigation control to provide a map to see where the restaurant is and/or get directions to the restaurant, which when interacted with takes the user to a mapping service endpoint that is also not managed by the restaurant web site. The same web site preview may provide a navigations control that when interacted with takes a user to a review service that is also not managed by the restaurant web site. Thus, the controls may provide functionalities that link to services that are familiar to the user, and thus are easily and comfortably navigated. Furthermore, the web site that has the preview need not themselves provide the services that underlie each control in the preview. Instead, the controls may link to endpoints that are outside of the domain of the web site.

As an example of an input control, there may be an input control that allows the user to add their name to a waitlist, which when interacted with provides a user identifier to the endpoint that registers those waiting for a table. As an example of an output control, the restaurant may generate an output control that shows wait time, which updates to reflect a time estimate for minutes remaining until their table is available. As another example of an output control this time in the context of an airline web site, the output control may update to reflect the real-time status of a flight (e.g., on time, in flight, delayed, landed, and so forth) of a flight. There might be another control that may be interacted with to connect to a flight tracker service, to thereby present the user with a flight tracking update.

Because the principles described herein are performed in the context of a computing system, some introductory discussion of a computing system will be described with respect to FIG. 9. Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 9, in its most basic configuration, a computing system 900 includes at least one hardware processing unit 902 and memory 904. The processing unit 902 includes a general-purpose processor. Although not required, the processing unit 902 may also include a field programmable gate array (FPGA), an application specific integrated circuit (ASIC), or any other specialized circuit. In one embodiment, the memory 904 includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

The computing system 900 also has thereon multiple structures often referred to as an “executable component”. For instance, the memory 904 of the computing system 900 is illustrated as including executable component 906. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 904 of the computing system 900. Computing system 900 may also contain communication channels 908 that allow the computing system 900 to communicate with other computing systems over, for example, network 910.

While not all computing systems require a user interface, in some embodiments, the computing system 900 includes a user interface system 912 for use in interfacing with a user. The user interface system 912 may include output mechanisms 912A as well as input mechanisms 912B. The principles described herein are not limited to the precise output mechanisms 912A or input mechanisms 912B as such will depend on the nature of the device. However, output mechanisms 912A might include, for instance, speakers, displays, tactile output, virtual or augmented reality, holograms and so forth. Examples of input mechanisms 912B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

1. A service computing system that generates a preview of a website based on a determined type for the website, said service computing system comprising:
one or more processors; and
one or more computer-readable media having thereon instructions that are executable by the one or more processors to cause the service computing system to:
receive a website identifier corresponding to a website;
in response to the received website identifier, access metadata for the website, wherein the metadata includes a type field that includes information describing a type for the website;
based on the information included in the type field of the metadata, determine the type for the website;
select a preview template based on the type of the website;
generate preview data that represents a preview of the website, wherein generating the preview data includes populating the preview template with content from the website, wherein the preview data is structured to be interpreted by a client computing system to cause the client computing system to display the preview of the website; and
cause the preview data to be sent to the client computing system causing the client computing system to display the preview of the website based on the preview template.

2. The service computing system of claim 1, wherein selecting the preview template based on the type of the website includes:
determining that a particular preview template has been registered by an owner of the website for the type of the website; and
selecting the particular preview template as the preview template.

3. The service computing system of claim 1, wherein the website specifies compliance with a schema associated with the website.

4. The service computing system of claim 1, wherein the website specifies compliance with a schema, and wherein the schema specifies a position in the metadata where the type of the site is located.

5. The service computing system of claim 1, wherein the service computing system is further configured to:
determine context information for the preview of the website, the context information representing a context in which the preview for the website is to be displayed; and
select the preview template based on the context information.

6. The service computing system of claim 1, wherein the service computing system is further caused to:
determine a screen size of the client computing system; and
select the preview template based on the screen size.

7. The service computing system of claim 1, wherein the preview data includes an action control associated with an endpoint that is different than the website.

8. The service computing system of claim 1, the type of the website being a restaurant type.

9. The service computing system of claim 1, the type of the website being a product type.

10. The service computing system of claim 1, the type of the website being an airline type.

11. The service computing system of claim 1, wherein the preview data is in a data interchange text format.

12. A computer-implemented method for generating a preview of a website based on a determined type for the website, the method comprising:
receiving a website identifier corresponding to a website;
in response to the received website identifier, accessing metadata for the website, wherein the metadata includes a type field that includes information describing a type for the website;
based on the information included in the type field of the metadata, determining the type for the website;
selecting a preview template based on the type of the website;
generating preview data that represents a preview of the website, wherein generating the preview data includes populating the preview template with content from the website, wherein the preview data is structured to be interpreted by a client computing system to cause the client computing system to display the preview of the website; and
causing the preview data to be sent to the client computing system causing the client computing system to display the preview of the website based on the preview template.

13. The method of claim 12, wherein selecting the preview template includes:
determining that a particular preview template has been registered by an owner of the website for the type of the website; and
particular preview template as the preview template.

14. The method of claim 12, wherein the website specifies compliance with a schema associated with the website.

15. The method of claim 12, wherein the website specifies compliance with a schema, and wherein the schema specifies a position in the metadata where the type field is located.

16. The method of claim 12, wherein generating the preview data includes:
determining context information for the preview website, wherein the context information represents a context in which the preview of the website is to be displayed; and
selecting the preview template based on the context information.

17. The method of claim 12, wherein generating the preview data includes:
determining a screen size of the client computing system; and
selecting the preview template based on the screen size.

18. The method of claim 12, wherein the preview data includes an action control for an endpoint that is different than the website.

19. The method of claim 12, the type of website being a restaurant type, a product type, or an airline type.

20. (canceled)

21. A method for generating a preview of a website based on a determined type for the website, the method comprising:
accessing metadata for a website, wherein the metadata includes a type field that includes information describing a type for the website, wherein the website specifies compliance with a schema associated with the website, and wherein a position of the type field within the metadata is defined by the schema;
based on the information included in the type field of the metadata, determining the type for the website;
selecting a preview template based on the type of the website;
generating preview data that represents a preview of the website, wherein generating the preview data includes populating the preview template with content from the website, wherein the preview data is structured to be interpreted by a client computing system to cause the client computing system to display the preview of the website; and
causing the preview data to be sent to the client computing system.
